(19) United States
(12) Patent Application Publication
(10) Pub. No.: US 2002/0004462 A1
(43) Pub. Date: Jan. 10, 2002

(54) HIGH-FREQUENCY CIRCUIT ELEMENT

(75) Inventors: AKIRA ENOKIHARA, NARA (JP); KENTARO SETSUNE, OSAKA (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Osaka (JP)

(21) Appl. No.: 09/073,102

(22) Filed: May 5, 1998

(30) Foreign Application Priority Data
May 8, 1997 (JP) 9-117859

(51) Int. Cl. H01P 7/08

(52) U.S. Cl. 505/210; 333/99 S; 333/219

(57) ABSTRACT

A high-frequency circuit element that realizes a high degree of input-output coupling without causing an increase in loss and irregularity in impedance. A resonator made of a conductor film is formed on a substrate made of a dielectric monocrystal or the like. An input-output line made of a conductor film having a uniform line width is formed on the same surface of the substrate as the surface on which the resonator is formed. A part of the side edge of the input-output line is located along a coupling part on the peripheral part of the resonator and spaced from the resonator by a gap part.

### FIELD OF THE INVENTION

The present invention relates to a high-frequency circuit element, such as a resonator, a filter or the like, used for a high-frequency signal processor in communication systems, etc.

### BACKGROUND OF THE INVENTION

A high-frequency circuit element, such as a resonator, a filter or the like, is an essential component in high-frequency communication systems. The main examples of high-frequency circuit elements such as resonators, filters or the like presently used are those using a dielectric resonator, those using a transmission line structure (a microstrip structure or a strip line structure), and those using a surface acoustic wave element. Among them, those using a transmission line structure are small and can be applied to frequencies as high as microwaves or milliwaves. Furthermore, they have a two-dimensional structure formed on a substrate and easily can be combined with other circuits or elements, and therefore they are widely used. Conventionally, a half-wavelength resonator with a transmission line is most widely used as this type of resonator. Also, by coupling a plurality of these half-wavelength resonators, a high-frequency circuit element such as a filter or the like is formed (Minute Explanation Examples/Exercises Microwaves Circuit Tokyo Electrical Engineering College Publishing Office).

Other conventional examples of a transmission line structure include those using a planar circuit structure. The representative examples are those constructing various high-frequency circuits by using a disc type resonator (Papers of Institute of Electronics and Communication Engineers of Japan, 72/8 Vol.55-B No.8 “Analysis of Microwave Planar Circuit” Tanroku MIYOSHI, Takaaki OOKOSHI).

However, in a resonator having a transmission line structure such as a half-wavelength resonator or the like, high-frequency current is concentrated in a part in a conductor. Therefore, loss due to conductor resistance is relatively large, resulting in degradation in the Q value in the resonator and also an increase in loss when a filter is formed. Also, when using a half-wavelength resonator having a commonly used microstrip structure, the effect of loss due to radiation from a circuit to space is a problem.

In the case of using a round resonator or the like as a resonator in a planar circuit structure, it is difficult to obtain a high degree of coupling that satisfies a filter design parameter in a coupling part between an input-output line and the resonator. The following technique has been proposed as a method for obtaining a high degree of input-output coupling (FIGS. 12 and 13). That is to say, as shown in FIG. 12, a notch 30a is formed in a part of a resonator 30 and the point of an input-output line 31 is inserted into the notch 30a. This enables the degree of input-output coupling to be increased by increasing coupling capacity (T. Hayashi and others, Electronics Letters, Vol. 30, No. 17 pp. 1424). As shown in FIG. 13, the line width of the point 31a of an input-output line 31 is broadened, and the point 31a having the broadened line width is located facing the peripheral part of the resonator 30. This enables the degree of input-output coupling to be increased by increasing the coupling capacitance.

However, even when using these methods, there is a limit to the increase in the degree of input-output coupling. In the former method (FIG. 12), since the notch 30a is formed in a part of the resonator 30, the current is concentrated at this part, thus causing an increase in loss. On the other hand, in the latter method (FIG. 13), the irregularity in impedance is caused by broadening the line width at the point 31a of the input-output line 31. Conversely, when making the line width of the point 31a too broad, the degree of input-output coupling decreases.

### SUMMARY OF THE INVENTION

The present invention aims to solve the problems mentioned above in the prior art. The object of the present invention is to provide a high-frequency circuit element that can realize a high degree of input-output coupling without causing an increase in loss and irregularity in impedance.

In order to attain the object mentioned above, an aspect of a high-frequency circuit element according to the present invention comprises at least one resonator having a planar circuit structure and at least one input-output line, and is characterized in that the input-output line has a side edge and a part of the side edge of the input-output line is located along a coupling part on the peripheral part of the resonator and spaced from the resonator by a gap part. According to this aspect of the high-frequency circuit element, distributed coupling can be made by locating a part of the side edge of the input-output line along the coupling part on the peripheral part of the resonator, and spaced therefrom through the gap part. As a result, a high degree of input-output coupling can be realized without changing the peripheral shape of the resonator and the line width of the input-output line at the coupling part as in a conventional high-frequency circuit element, that is, without causing an increase in loss and irregularity in impedance.

In the aspect of the high-frequency circuit element of the present invention mentioned above, it is preferable that the input-output line has a substantially uniform width.

In the aspect of the high-frequency circuit element of the present invention mentioned above, a resonator having any shape, such as a round resonator, an elliptical resonator, a polygonal resonator or the like, can be used as the resonator in a planar circuit structure.

In the aspect of the high-frequency circuit element of the present invention mentioned above, the length of the coupling part defines the angle with respect to the center of the resonator. It is preferable that the angle is set in the range of 5-30°.

In the aspect of the high-frequency circuit element of the present invention mentioned above, it is preferable that the distance between the coupling part on the periphery of the resonator and the input-output line (the gap part) is set in the range of 10-500 μm.

It is preferable that the high-frequency circuit element of the present invention mentioned above has a microstrip structure or a strip line structure. The microstrip structure is simple in structure and has good coherency with other circuits. The strip line structure enables a high-frequency circuit element having small loss to be realized, since the radiation loss is very small.

In the aspect of the high-frequency circuit element of the present invention mentioned above, it is preferable that an elliptical resonator is used as a resonator in a planar circuit structure and two input-output lines are coupled to the resonator, wherein the coupling parts are in the vicinity of the intersections of the periphery of the resonator with the major axis of the ellipse and the minor axis of the ellipse respectively and are provided at the positions about 90° apart from each other with respect to the center of the resonator. This preferable example can be operated as a band pass filter. It is conceivable that it can be operated as a two-stage resonator coupled filter by utilizing the coupling between two resonance modes of the elliptical resonator.

In the aspect of the high-frequency circuit element of the present invention mentioned above, it is preferable that a superconductor is used as a material of the resonator. According to this preferable example, a high-frequency circuit element having small loss and excellent power endurance characteristics can be realized.

### BRIEF DESCRIPTION OF THE DRAWINGS

FIG. 1 is a plan view showing a first embodiment of a high-frequency circuit element according to the present invention.

FIG. 2 is a cross-sectional view along line II-II in FIG. 1.

FIG. 3 is a graph showing reflection characteristics of a high-frequency circuit element of the first embodiment of the present invention.

FIG. 4 is a plan view showing another aspect of the first embodiment of a high-frequency circuit element according to the present invention.

FIG. 5 is a graph showing reflection characteristics of another aspect of a high-frequency circuit element of the first embodiment of the present invention.

FIG. 6 is a graph showing the relationship between the length of the coupling part and the degree of input-output coupling in another aspect of a high-frequency circuit element of the first embodiment of the present invention.

FIG. 7 (a) and (b) are plan views showing additional aspects of a high-frequency circuit element of the first embodiment of the present invention.

FIG. 8 is a plan view showing a second embodiment of a high-frequency circuit element according to the present invention.

FIG. 9 is a graph showing input-output characteristics of a high-frequency circuit element of the second embodiment of the present invention.

FIG. 10 is a graph showing insertion loss characteristics with respect to input power in a high-frequency circuit element of the second embodiment of the present invention.

FIG. 11 is a cross-sectional view showing a high-frequency circuit element having a strip line structure of the present invention.

FIG. 12 is a plan view showing an example of a high-frequency circuit element in the prior art.

FIG. 13 is a plan view showing another example of a high-frequency circuit element in the prior art.

FIG. 14 is a graph showing a comparative example of the relationship between the length of the coupling part and the degree of input-output coupling in a high-frequency circuit element.

### PREFERRED EMBODIMENTS OF THE INVENTION

The present invention is described further using concrete embodiments as follows.

<First Embodiment>

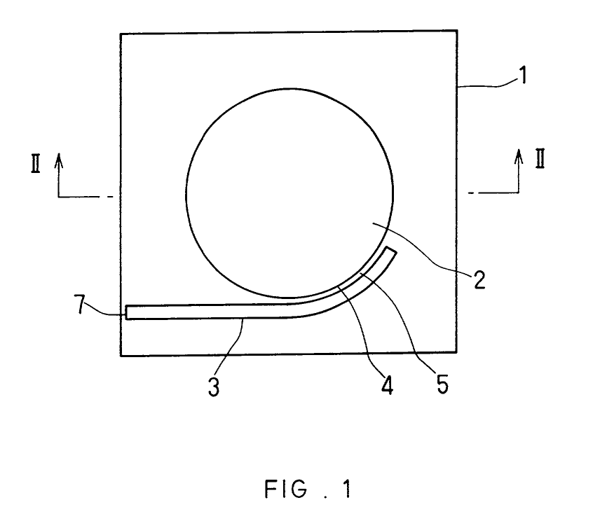

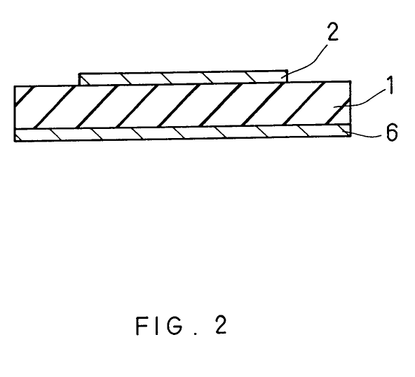

FIG. 1 is a plan view showing a first embodiment of a high-frequency circuit element according to the present invention. FIG. 2 is a cross-sectional view along line II-II in FIG. 1. As shown in FIGS. 1 and 2, a round resonator 2 made of a conductor film is formed at the center on a substrate 1 made of a dielectric monocrystal or the like by using, for example, a vacuum evaporation method and etching. An input-output line 3 made of a conductor film is formed on the same surface of the substrate 1 as the surface on which the resonator 2 is formed by using, for example, a vacuum evaporation method and etching. In this case, the input-output line 3 has a side edge and its line width is uniform. In addition, a part of the side edge of the input-output line 3 is located along a coupling part 4 on the peripheral part of the resonator 2 and spaced from the resonator by a gap part 5. A ground plane 6 made of a conductor film is formed on the entire back surface of the substrate 1 by using, for example, a vacuum evaporation method. This enables a high-frequency circuit element having a microstrip structure to be realized.

As a material of the conductor film, a high-temperature oxide superconductor represented by a yttrium (Y) family superconductor such as YBa₂Cu₃Oₓ or the like, a bismuth (Bi) family superconductor such as Bi₂Sr₂Ca₂Cu₃Oₓ or the like, a thallium (Tl) family superconductor such as Tl₂Ba₂CaCu₂Oₓ or the like; a metallic superconductor such as Nb or the like; or a metal such as gold, copper or the like, etc. can be used.

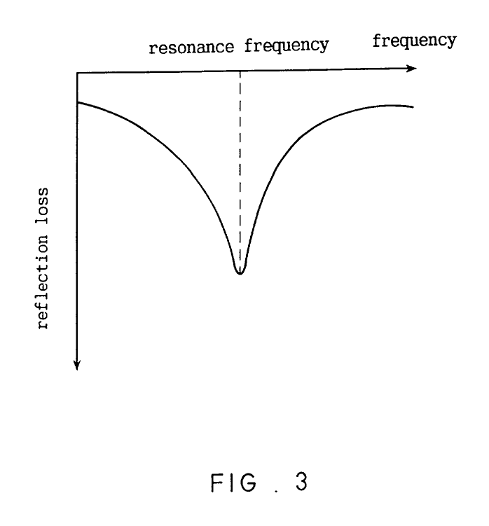

When inputting a high-frequency signal from a terminal part 7 of the input-output line 3 in a high-frequency circuit element having the structure mentioned above, the high-frequency signal couples with the resonator 2 at the coupling part 4, thus inducing resonance operation. In this case, the characteristic inherent in a resonance circuit that great absorption occurs at the resonance frequency of the resonator 2 can be obtained as shown in FIG. 3.

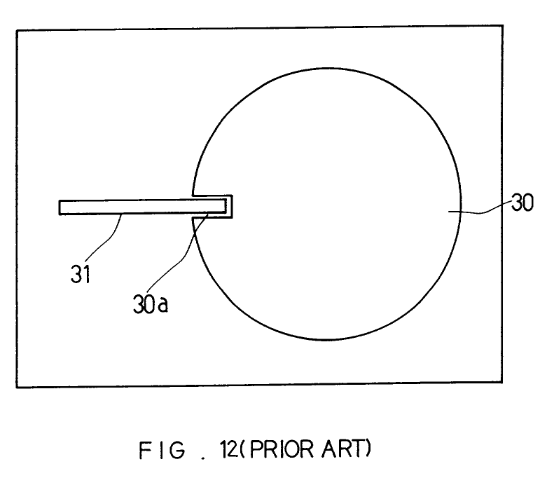

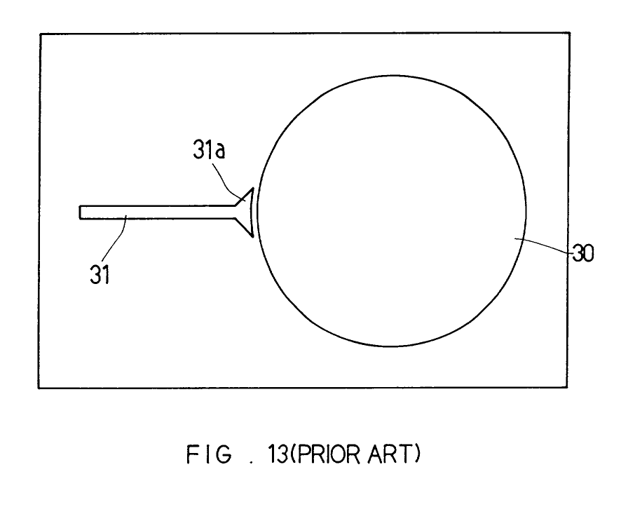

A conventional high-frequency circuit element shown in FIGS. 12 and 13 utilizes the effect of capacitive coupling alone depending on the capacity at a coupling part. However, in the high-frequency circuit element of the present embodiment, the effect of distributed coupling by a magnetic field is added. As a result, a higher degree of coupling can be obtained compared to that in the conventional high-frequency circuit element. That is to say, as in the present embodiment, the distributed coupling can be made by locating a part of the side edge of the input-output line 3 along the coupling part 4 on the peripheral part of the resonator 2, and spaced therefrom through the gap part 5. As a result, a high degree of input-output coupling can be realized without changing the peripheral shape of the resonator 2 at the coupling part 4 and the line width of the input-output line 3, in other words, without causing an increase in loss and irregularity in impedance as in the conventional high-frequency circuit element shown in FIGS. 12 and 13.

The present invention is to be described further in detail referring to examples of the present embodiment as follows.

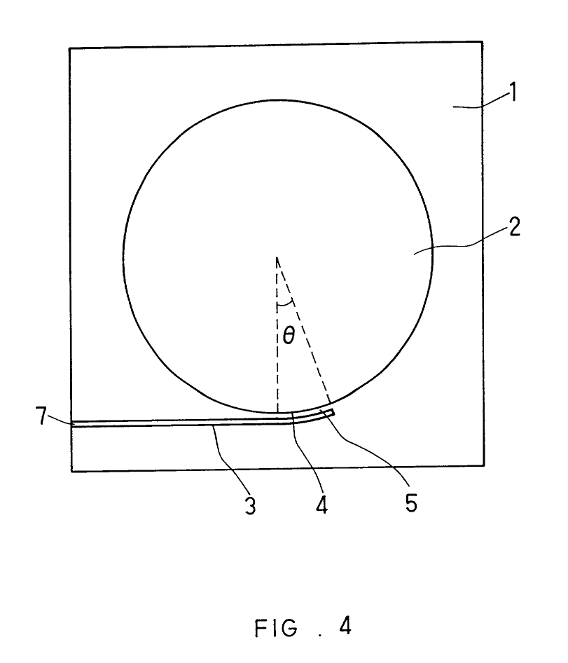

FIG. 4 is a plan view showing another aspect of the first embodiment of the high-frequency circuit element according to the present invention. As shown in FIG. 4, a round resonator 2 made of a thallium-based high-temperature oxide superconductor having a thickness of 0.7 μm is formed at the center on a substrate 1 made of a lanthanum alumina (LaAlO₃) monocrystal having a thickness of 0.5 mm. In this case, the radius of the resonator 2 is 9.53 mm. An input-output line 3 also made of a thallium-based high-temperature oxide superconductor having a thickness of 0.7 μm and a line width of 0.175 mm is formed on the same surface of the substrate 1 as the surface on which the resonator 2 is formed. A part of the side edge of the input-output line 3 is located along the coupling part 4 on the peripheral part of the resonator 2, spaced from the resonator by the gap part 5. In this case, the distance between the coupling part on the periphery of the resonator and the input-output line (the gap part 5) is 20 μm. The length of the coupling part 4 is indicated by the angle θ seen with respect to the center of the resonator 2. A ground plane (not shown in the figure) also made of a thallium-based high-temperature oxide superconductor having a thickness of 0.7 μm is formed on the entire back surface of the substrate 1.

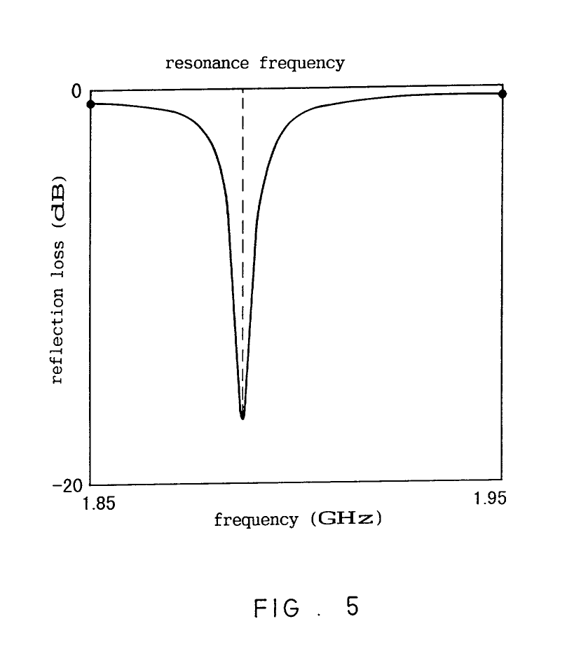

In FIG. 5, the reflection characteristic in the case of θ=10° is shown. As shown in FIG. 5, it can be seen that the characteristic inherent in a resonance circuit that great absorption occurs at the resonance frequency of the resonator 2 can be obtained.

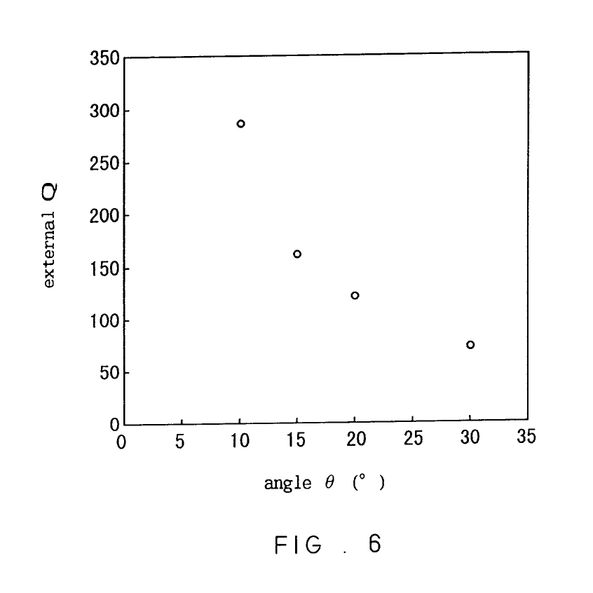

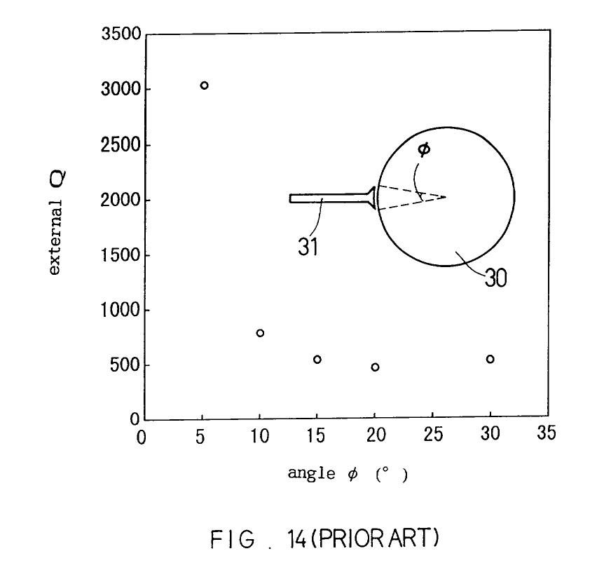

In FIG. 6, the change in the degree of input-output coupling when changing the angle θ is shown. The higher degree of input-output coupling can be obtained as the external Q of the resonance circuit becomes small. Therefore, the degree of input-output coupling herein is indicated by the external Q of the resonance circuit. As shown in FIG. 6, in the case of θ=20° , an external Q of about 120 is obtained. In the case of increasing the angle up to about θ=30° , it can be seen that the degree of input-output coupling increases. For the purpose of comparison, the change in the degree of input-output coupling in the conventional high-frequency element shown in FIG. 13 is shown in FIG. 14. In this case, the opening angle of the point of an input-output line 31 is indicated by an angle ∅ seen with respect to the center of a disc resonator 30. The distance between the point of the input-output line 31 and the disc resonator 30 (the gap part) is set to 20 μm as in FIG. 4. The structure is the same as that in FIG. 4 except for the input-output coupling part. As shown in FIG. 14, when making the angle ∅ wider in the conventional high-frequency circuit element shown in FIG. 13, the highest degree of input-output coupling (the external Q of about 450) can be obtained in the vicinity of 20° . When the angle ∅ is made wider than that, on the contrary, the external Q becomes greater. That is, the degree of input-output coupling becomes lower when making the angle ∅ wider than 20° . Thus, it is conceivable that since the intrinsic impedance of the input-output line 31 changes rapidly when the line width of the point of the input-output line 31 becomes broad and therefore an input-output signal is reflected, the degree of input-output coupling becomes low when making the angle ∅ wide to some extent. Therefore, when making a comparison under the same conditions, it is possible to decrease the external Q to around 100 in the structure of a high-frequency circuit element according to the present embodiment, but it is impossible to obtain a high degree of input-output coupling having the external Q of 450 or less in the structure of the conventional high-frequency element shown in FIG. 13.

As described above, it becomes possible to obtain a high degree of input-output coupling that has been impossible to realize in the conventional structure by employing the structure of a high-frequency circuit element according to the present embodiment. The structure of the present embodiment is very effective, since a relatively high degree of input-output coupling is generally required in resonator coupling type high-frequency filters.

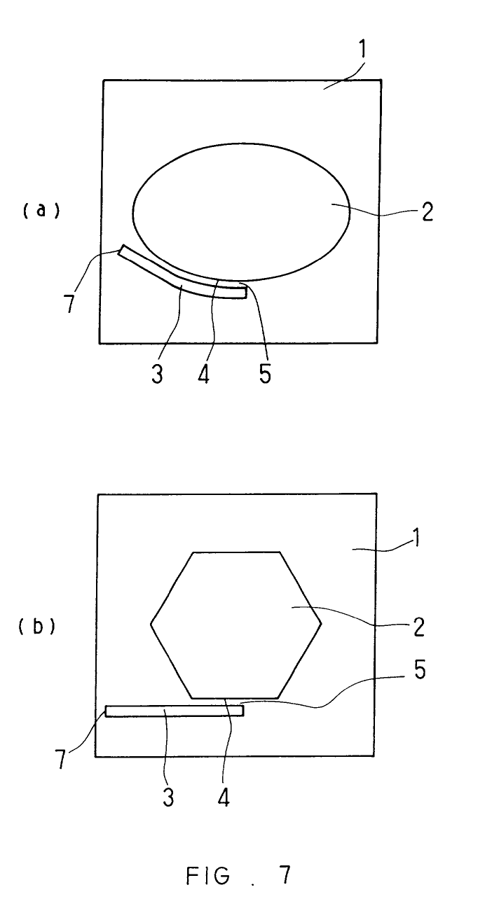

The present embodiment was described referring to an example using the round resonator 2 as a resonator in a planar circuit structure. However, the present invention is not always limited to this configuration. As a resonator in a planar circuit structure, a resonator having any shape such as, for example, an elliptical resonator shown in FIG. 7(a) and a polygonal resonator shown in FIG. 7(b) can be used besides the round resonator. A high-frequency circuit element using a resonator having such a shape is also effective due to the same reasons as mentioned above.

The present embodiment was described referring to an example using a high-frequency circuit element comprising one resonator 2 and one input-output line 3. However, the present invention is not always limited to this configuration. The present invention can be applied to, for example, a high-frequency circuit element such as a multistage filter using a plurality of resonators and a plurality of input-output lines and a high-frequency circuit element including a resonator and an input-output line as its part, and the same effectiveness can be exhibited.

<Second Embodiment>

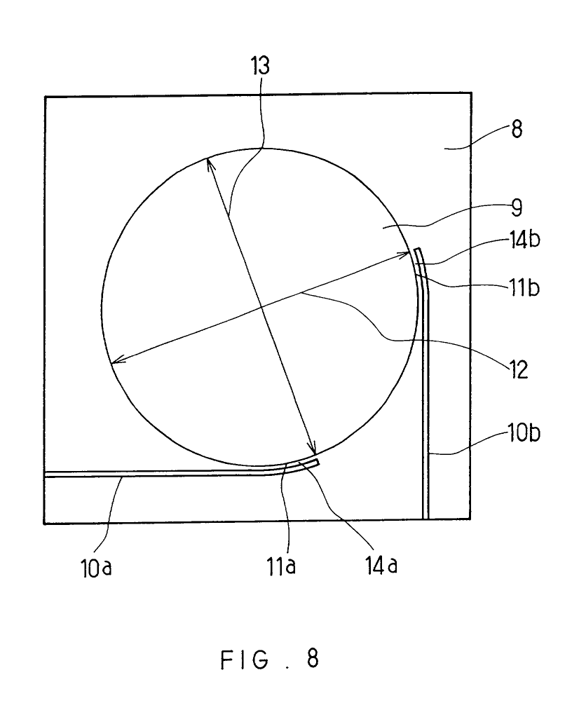

FIG. 8 is a plan view showing a second embodiment of a high-frequency circuit element according to the present invention. As shown in FIG. 8, an elliptical resonator 9 made of a conductor film is formed at the center on a substrate 8 made of a dielectric monocrystal or the like by using, for example, a vacuum evaporation method and etching. The lengths of the major axis 12 and the minor axis 13 of the elliptical resonator 9 are set to 19.07 mm and 18.93 mm respectively. Using, for example, a vacuum evaporation method and etching, input-output lines 10a and 10b made of conductor films are formed on the same surface of the substrate 8 as the surface on which the resonator 9 is formed. In this case, the input-output lines 10a and 10b have side edges and their line widths are uniform. In addition, a part of the side edges of the input-output lines 10a and 10b is located along the coupling parts 11a and 11b on the peripheral part of the resonator 9, spaced from the resonator by the gap parts 14a and 14b respectively. In this case, coupling parts 11a and 11b are in the vicinity of the intersections of the periphery of the resonator 9 with the major axis 12 and the minor axis 13 respectively and are located at the positions that located 90° apart from each other as seen with respect to the center of the resonator 9. Both lengths of the coupling parts 11a and 11b are set to the lengths corresponding to an angle of 18° seen from the center of the resonator 9. On the entire back surface of the substrate 8, a ground plane (not shown in the figure) made of a conductor film is formed by using, for example, a vacuum evaporation method. This realizes a high-frequency circuit element having a microstrip structure.

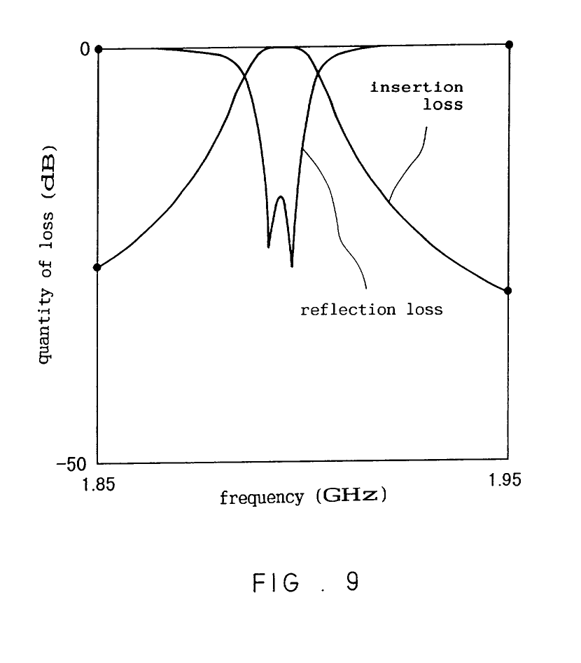

FIG. 9 shows input-output characteristics for a high-frequency circuit element having such a structure as mentioned above. As shown in FIG. 9, a flat transmission characteristic can be obtained in the vicinity of 1.9 GHz in this element. Therefore, it can be found that the element operates as a band pass filter. This shows that the element can be operated as a two-stage resonator coupled filter by utilizing the coupling between two resonant modes of an elliptical resonator. In this type of filter, the peripheral part of the elliptical resonator is very smooth and the effect of current concentration within the resonator is small. Therefore, in the case of using an ordinary metal as a material of the resonator, the loss is smaller than that in the conventional structure.

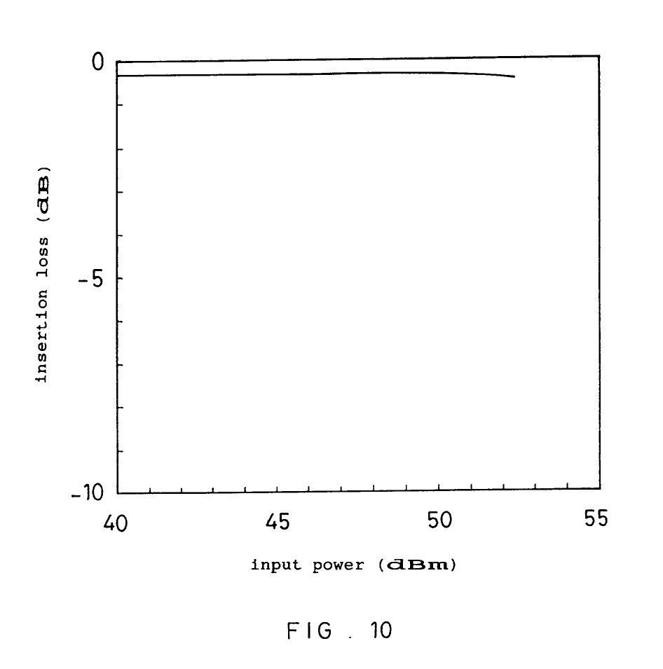

FIG. 10 shows the dependence on input power of insertion loss in a passing band of a high-frequency circuit element having such a structure as mentioned above. A HP85108A pulsed RF network analyzer system manufactured by Hewlett Packard was used for the measurement. In this case, the measurement was conducted using a pulsed power signal having a pulse width of 2 μsec. so as not to be affected by generating heat in a cable for inputting-outputting signals into the element part. The environmental tempertature was 20 kelvin. As can be seen from FIG. 10, no clear change in the insertion loss for the input power up to +50 dBm (100W) was found. In superconducting filters having a conventional structure, superconductivity is lost even for the input signal in a level of only tens of mW (about +15 dBm), thus becoming incapable of operating. Therefore, it can be found that the power endurance capacity of the present high-frequency circuit element is extremely excellent. This can be achieved by the following reasons: in the present high-frequency circuit element, the current concentration at the input-output line part and the resonator part is retained in a very low level; since the loss in the entire element is very small, the effect of generating heat corresponding to the loss is very small; and the like. This shows the effectiveness of the present high-frequency circuit element clearly.

On the other hand, in the case of using the conventional input-output coupling structure shown in FIG. 13 as the coupling part in the high-frequency circuit element of the present embodiment, the required degree of input-output coupling (the external Q=about 130) cannot be obtained. As a result, the input-output characteristics as shown in FIG. 9 cannot be obtained. This can be easily understood by comparing FIG. 6 with FIG. 14. In the case of using the conventional input-output coupling structure shown in FIG. 12, an abrupt change is given to the peripheral part of the resonator, and therefore localized concentration of current occurs within the resonator, thus causing a loss increase.

From the results mentioned above, it can be found that the structure of the high-frequency circuit element according to the present embodiment shown in FIG. 8 is very effective.

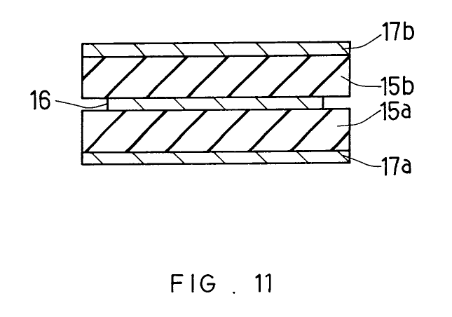

The embodiment mentioned above was described referring to a high-frequency circuit element having a microstrip structure. However, the present invention is not always applied only to the high-frequency circuit element having this structure. For example, the configuration of the present invention is also effective for a high-frequency circuit element having a strip line structure as shown in FIG. 11. In FIG. 11, each of numerals 15a and 15b indicates a substrate, numeral 16 indicates a resonator and each of numerals 17a and 17b indicates a ground plane. The strip line structure is a complex structure compared to the microstrip structure. However, the radiation loss becomes small and therefore the characteristics of the element can be improved.

The embodiment mentioned above was described referring to an example using an ordinary metal as a material of the resonator, but a superconductor can be used as a material of the resonator as well as the ordinary metals. When using a superconductor as a material of the resonator, a high-frequency circuit element having small loss and excellent power endurance characteristics can be realized. On the other hand, the use of a superconductor as a material of a resonator and a conventional input-output coupling structure shown in FIG. 12 causes the degradation in the power endurance characteristics.

A metal-based material (for example, a Pb-based material such as Pb, PbIn or the like, and a Nb-based material such as Nb, NbN, Nb₃Ge or the like) may be used as a superconductor. However, in practical use, it is desirable to use a high-temperature oxide superconductor (for example, Ba₂YCu₃O₇) whose temperature condition is relatively lenient.

However, in the case of using a superconductor as a material of the resonator, superconducting current over the value of critical current density can not be applied. This becomes a problem in the case of handling a high-frequency signal having high power. In the high-frequency circuit element of the present invention, a resonator having a planar circuit structure is used that can effectively relieve the concentration of high-frequency current at the peripheral part of the resonator where the current is most extremely concentrated in the conventional structure. In addition, a high degree of input-output coupling can be obtained without changing the peripheral shape. Therefore, the maximum electric current density in the case of handling a high-frequency signal having the same power becomes lower than that in the conventional one. Consequently, in the case of constructing a high-frequency circuit element of the present invention using a superconductor having the same critical current density, it becomes possible to handle a high-frequency signal having further higher power. Thus, the effectiveness of the present invention is extremely high.

As described above, when employing the configuration of a high-frequency circuit element according to the present invention, a higher degree of input-output coupling for the resonator having a planar circuit structure can be obtained compared to that in the conventional one and the degree of freedom in designing a high-frequency circuit increases, thus realizing a high-performance high-frequency circuit element.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. A high-frequency circuit element, comprising at least one resonator having a planar circuit structure and at least one input-output line, wherein the input-output line has a side edge and a part of the side edge of the input-output line is located along a coupling part on the peripheral part of the resonator and spaced from the resonator by a gap part.

2. A high-frequency circuit element according to claim 1, wherein the input-output line has a substantially uniform width.

3. A high-frequency circuit element according to claim 1, wherein a round resonator is used as the resonator having a planar circuit structure.

4. A high-frequency circuit element according to claim 1, wherein an elliptical resonator is used as the resonator having a planar circuit structure.

5. A high-frequency circuit element according to claim 1, wherein a polygonal resonator is used as the resonator having a planar circuit structure.

6. A high-frequency circuit element according to claim 1, wherein the length of the coupling part defines an angle with respect to the center of the resonator and the angle is set in the range of 5-30° .

7. A high-frequency circuit element according to claim 1, wherein the distance between the coupling part on the periphery of the resonator and the input-output line is set in the range of 10-500 μm.

8. A high-frequency circuit element according to claim 1, having a microstrip structure.

9. A high-frequency circuit element according to claim 1, having a strip line structure.

10. A high-frequency circuit element according to claim 1, wherein an elliptical resonator is used as a resonator having a planar circuit structure and two input-output lines are coupled to the resonator, the coupling parts being in the vicinity of the intersections of the periphery of the resonator with the major axis of the ellipse and the minor axis of the ellipse respectively and being located at the positions about 90° apart from each other with respect to the center of the resonator.

11. A high-frequency circuit element according to claim 1, wherein a superconductor is used as a material of the resonator.
